(19) United States
(12) Patent Application Publication
(10) Pub. No.: US 2026/0147646 A1
(43) Pub. Date: May 28, 2026

(54) Parallel-Split All-to-All Data Communication

(71) Applicant: Advanced Micro Devices, Inc., Santa Clara, CA (US)

(72) Inventors: Mithun Mohan Kadavil Madana Mohanan, Thrissur (IN); Nithya Viswanathan Shyla, Thiruvananthapuram (IN)

(73) Assignee: Advanced Micro Devices, Inc., Santa Clara, CA (US)

(21) Appl. No.: 18/959,130

(22) Filed: Nov. 25, 2024

(51) Int. Cl. G06F 9/54

(52) U.S. Cl. CPC G06F 9/546

(57) ABSTRACT

Parallel-split all-to-all data communication is described. An average latency between ranks among which data blocks are to be exchanged is estimated. A split factor is then derived based on the estimated rank-to-rank latency, a number of ranks involved in the all-to-all operation, as well as a size of a data block communicated between ranks. A parallel-split all-to-all system divides the ranks into a number of parallel groups defined by the split factor. Within each group, a linear all-to-all communication is performed. Once the parallel groups have completed their internal all-to-all communication, the parallel-split all-to-all system reorganizes the ranks into exchange groups using split factor. The parallel-split all-to-all system completes the all-to-all data transfer by causing ranks to exchange data blocks among one or more other ranks included in their respective exchange group.

### BACKGROUND

The all-to-all communication pattern in parallel computing, such as the one provided by MPI (Message Passing Interface), is essential for computational tasks where each process in a group requires data from all other processes in the group (e.g., to execute computations). For instance, this communication pattern arises in applications that involve distributed data structures or algorithms where the tasks are highly interdependent, and information must be shared across all participants.

As a specific example, in matrix transposition or data redistribution algorithms, every process may hold a portion of the data that must be exchanged with every other process. Similarly, in scientific simulations that involve multi-dimensional grids, each process might need boundary data from neighboring processes to compute updates for its part of the grid. The all-to-all communication pattern ensures that all processes have the necessary information to proceed with their tasks.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of a processing system configured to execute one or more applications, in accordance with one or more implementations.

FIG. 2 depicts a procedure in an example implementation of the parallel-split all-to-all system of FIG. 1 performing data communication among a group of ranks using the techniques described herein.

FIG. 3 depicts a procedure in an example implementation of the parallel-split all-to-all system of FIG. 1 estimating a rank-to-rank communication latency between different ranks implemented by the processing system of FIG. 1.

FIG. 4 depicts an example of different hierarchical memory structures that result in different rank-to-rank latencies.

FIG. 5 depicts a procedure in an example implementation of the parallel-split all-to-all system of FIG. 1 deriving a split factor for use in performing a parallel-split all-to-all operation in accordance with the techniques described herein.

FIG. 6 depicts an example of ranks that include data blocks to be transferred, from a given rank to each other rank, during an all-to-all operation.

FIG. 7 depicts an example of ranks that have been divided into parallel groups based on a split factor derived for an all-to-all operation using the techniques described herein.

FIG. 8 depicts an example of ranks that have performed a linear all-to-all operation with other ranks of their parallel group as part of performing a parallel-split all-to-all operation.

FIG. 9 depicts an example of ranks that have been assigned into exchange groups based on a split factor derived for an all-to-all operation using the techniques described herein.

FIG. 10 depicts an example of ranks of a given exchange group that have received data blocks from other ranks of the exchange group as part of a parallel-split all-to-all operation using the techniques described herein.

### DETAILED DESCRIPTION

The all-to-all communication pattern, such as the one provided by MPI (Message Passing Interface), is used in a wide range of tasks involving complex computational workflows, such as machine learning training, signal processing, large-scale data simulations, and so forth. During an all-to-all operation, a group of P processes, or “ranks,” (where P represents the total number of processes, or ranks, numbered from 0 to P−1), is tasked with redistributing data, such that each rank sends data to every other process. Initially, each rank holds its own data that needs to be shared with all other ranks. Due to the collective nature of the all-to-all operation, each rank initially holds P data blocks, which can conceptually be represented using labels that identify both a rank of origin and a rank to which the data block will ultimately be sent upon completion of the all-to-all operation. For instance, in rank 0, its data blocks can be conceptually labeled as r0d0, r0d1, r0d2, . . . r0dP−1. The “r” prefix of this conceptual labeling indicates that the data block originates from rank 0, while the “d #” suffix indicates the destination rank of the data block (for example, rod3 will be communicated to rank 3 at completion of the all-to-all operation).

Although referred to herein with respect to this conceptual labeling, it is important to note that there is no intrinsic identifier within, or otherwise appended to, a data block that defines its source rank or its destination rank. Rather, it is the position of a data block within a rank's data storage system (e.g., data buffer) that provides the information represented with respect to the conceptual labels noted above. For instance, consider a matrix with P rows and D columns, where P is the number of ranks, and D is the number of data blocks. Each element of the matrix represents a data block, and the matrix's layout determines how the data is exchanged between ranks. Each data block's position in the matrix defines both the source and destination of the block, as described in further detail below.

When depicted, the all-to-all operation is visualized as effectively transposing a matrix: the rows of the initial matrix (where each row belongs to a rank) are transformed into columns after the all-to-all operation. This redistribution means that each rank will ultimately hold data blocks received from all other ranks. For example, rank 0 will send a block of data to rank 1, rank 2, and so on, until all ranks have received one block of data from rank 0. A key aspect in performing the all-to-all operation is ordering of data, such that the received data within each rank must be structured so that data from rank 0 appears first, followed by data from rank 1, and so on, ensuring the correct sequence of communications.

Thus, an all-to-all operation for a group of ranks achieves communication of data from each rank to every other rank in the group. This communication pattern is often implemented for parallel computing tasks where processes need to exchange information with one another to complete a computation. Conventionally, all-to-all operations achieve data transfer among ranks using a static algorithm, such as a linear algorithm or a Bruck algorithm.

Using the linear algorithm, each rank sends data to every other rank in a sequential manner. For example, considering an example implementation where eight ranks are tasked with performing an all-to-all operation, rank 0 sends block r0d1 to rank 1, r0d2 to rank 2, and so on, until it has sent r0d7 to rank 7. This continues for every rank, and each rank sends a block of data to every other rank. In total, the linear algorithm requires P−1 communication rounds for each rank, and because every rank communicates with every other rank, the total number of communication rounds in the system is P(P−1).

Some conventional approaches vary a manner in which the linear algorithm is implemented, such as by changing an order in which data blocks are communicated. In one variation, each rank begins by sending data to a rank that is one position away (e.g., rank zero sends data to rank one; rank one sends data to rank two; etc.). In this variation, during a subsequent round, the rank sends data to a rank that is two positions away (e.g., rank zero sends data to rank two; rank one sends data to rank three; etc.), and so forth. Another variation involves sending data to even-numbered ranks first, followed by odd-numbered ranks. Regardless of the specific order, the linear algorithm requires each rank to communicate with P−1 other ranks.

The linear algorithm is well-suited for handling large data blocks (e.g., when each data block transferred between two ranks is multiple megabytes or greater), because the communication process between ranks involves two phases. The two phases include first establishing a communication channel between two ranks, and second, transferring the data block along the communication channel. For large data blocks, the time required to transfer a data block often outweighs the time required to establish the communication channel, which makes the linear algorithm more efficient for such cases.

In contrast to the linear algorithm, the Bruck algorithm is designed to be more efficient when the time required to transfer data is smaller than the time needed to establish a communication channel (e.g., when the data blocks are relatively small). In the Bruck algorithm, instead of each rank sending one block of data to every other rank, each rank sends multiple blocks of data to specific intermediary ranks. For example, rank 0 might send data blocks r0d1, r0d2, and r0d3 to rank 2. Rank 2 will then be responsible for distributing r0d1 and r0d3 to their appropriate destinations, rank 1 and rank 3, respectively. By having each rank send data to intermediary ranks, the number of communication channels that need to be established is reduced.

Continuing an example scenario where an all-to-all operation involves eight ranks, in the case of rank 0, for example, instead of sending data to all seven other ranks, it would only need to send data to ranks 2, 4, and 6, thereby reducing the number of communication channels it has to establish from seven to three. However, the trade-off is that more data must be transferred over each channel, as each intermediary rank is responsible for relaying some of the data blocks to their final destinations. The Bruck algorithm requires fewer communication steps, achieving a logarithmic reduction in communication rounds compared to the linear algorithm. For P ranks, the Bruck algorithm requires log_a (P) communication rounds, where “a” is the radix, which reduces computational system overhead when dealing with small data blocks (e.g., relative to the linear algorithm).

Existing all-to-all algorithms, such as the linear and Bruck algorithms, however, do not consider factors that dictate the optimal approach for transferring data blocks among a group of ranks, such as the number of ranks, the size of data blocks to be transferred, or underlying hardware architecture of the computing system used to perform the data transfer.

One critical factor that conventional algorithms do not consider is the hierarchical nature of memory in modern computing systems. For instance, many compute units (e.g., processor cores) use a multi-level cache system in addition to main memory (e.g., RAM). In some example architectures, each compute unit has its own L1 and L2 caches, which are private to that compute unit, while the L3 cache is shared among multiple compute units (e.g., multiple processor cores). For example, a set of eight cores might share a single L3 cache. In addition to the cache hierarchy, the main memory is accessible by all cores in the system.

This memory hierarchy is important because communication between processes sharing the same cache is significantly faster than communication between processes that do not share a cache. For instance, processes running on cores that share the same cache can exchange data more efficiently than processes running on cores located on different sockets. By optimizing the communication channels to favor processes that share cache resources, the overall performance of the data transfer can be improved. This can reduce the time required to complete the data transfer, decrease energy consumption, and improve the efficiency of the system.

Factors such as such as the number of ranks, the size of data blocks to be transferred, and underlying hardware architecture of the computing system used to perform the data transfer significantly impact an efficiency of performing the all-to-all operation, such as how much time or computational resources are required to complete the operation. Conventional approaches utilizing linear and Bruck algorithms to perform all-to-all operations are thus deficient because they are static (e.g., fixed) pattern of communication that unnecessarily consumes computational resources and induces undue delay for various scenarios involving different numbers of ranks, different data block sizes, different system hardware architectures, and combinations thereof.

To address these conventional shortcomings, parallel-split all-to-all data communication is described. In contrast to conventional algorithms for performing all-to-all operations, the parallel-split all-to-all techniques described herein dynamically adjusts an involved number of communication steps based on the message size (data block size) and the number of processes involved. As a further technical advantage not realized by conventional approaches, the parallel-split all-to-all techniques described herein also considers the underlying hardware of a computing system, such as a memory hierarchy and inter-rank communication latencies.

The parallel-split all-to-all techniques described herein first estimate an average latency between ranks (or processes) among which messages (e.g., data blocks) are to be exchanged. In implementations, the average rank-to-rank latency is not an exact measurement, but rather an approximate latency derived based on a computing system's hardware configuration, such as whether ranks share a common L3 cache, Non-Uniform Memory Access (NUMA) domain, socket, and so forth.

The techniques described herein are explained with reference to a non-limiting example hierarchical memory structure. For instance, in modern computer architectures (e.g., multi-core systems) memory is often organized hierarchically to optimize performance. One example is a computing system with multiple central processing units (CPUs), each with its own set of caches and memory regions. In such a system, each CPU is housed on a socket, and a system may have more than one socket. Within each socket, a CPU may have several cores, and each core can access different levels of cache, including L1, L2, and L3 caches.

In NUMA systems, memory is split into multiple domains (e.g., regions), where each domain is closer to certain CPUs (those on the same socket) and farther from others. This means memory access times are faster for the local CPUs but slower for others, leading to the concept of NUMA domain locality. The system tries to keep a CPU's memory accesses within its own domain to minimize latency. Each domain is composed of one or more CPUs (with their caches and cores), along with a segment of physical memory that those CPUs can access with lower latency. This hierarchical memory structure, with shared caches at various levels and domain-based memory, helps balance the trade-off between speed and capacity in accessing memory, allowing the system to manage resources efficiently in large multi-core, multi-socket environments.

While “L3 cache,” “NUMA domain,” “socket,” and “node” are used herein to describe specific levels within a hierarchical memory structure, these terms are not universally applied across all computing system architectures. They serve as non-limiting examples to illustrate one type of memory hierarchy. In other architectures, different terminology or configurations might be used to describe similar or entirely different concepts. For instance, some systems may only implement L1 and L2 caches or may have additional levels of caching beyond L3. Likewise, the term socket could be replaced with other hardware distinctions like modules or processors, and a node might be referred to as a cluster in some systems. Thus, although described with respect to specific terms, the described techniques are extendable to any suitable type of hierarchical memory structure employed by a computing system.

For a given hierarchical memory structure, an average latency between consecutive ranks is estimated. In implementations, this estimate is based on core distance, where the core distance refers to how far apart cores are in the shared resource hierarchy (e.g., cache, NUMA domain, socket, etc.). Cores belonging to different NUMA domains are distanced further apart than cores belonging to the same NUMA domain, while cores belonging to different sockets are even further apart than different NUMA domain cores, and so forth.

As a specific example, consider a scenario where there are eight ranks, with four ranks (0, 1, 2, and 3) sharing one L3 cache and the other four ranks (4, 5, 6, and 7) sharing a different L3 cache. In this scenario, the communication latency between adjacent ranks within the same L3 cache (e.g., rank 0 and rank 1) will be significantly lower than between ranks that do not share an L3 cache (e.g., rank 0 and rank 5). By identifying which ranks can communicate more efficiently, the described techniques optimize the ordering and grouping of data exchanges to minimize overall communication time. Rather than relying on fixed latency measurements, the described techniques estimate average communication times, thus ensuring adaptation to the specific hardware characteristics of a given computing system.

Given the estimated rank-to-rank latency, a split factor F is then derived for performing a parallel-split all-to-all operation. In addition to being derived based on the estimated rank-to-rank latency, the split factor is further derived based on a number of ranks P involved in the all-to-all operation as well as a size of a data block communicated between ranks, or a “message block” size m. In implementations, m is expressed in bytes.

In implementations, the split factor is calculated using a heuristic model that considers the message block size and communication latencies between ranks. A smaller message size and a larger number of ranks generally result in a higher split factor. The described techniques perform parallel-split all-to-all operations when the split factor is greater than one (e.g., when the split factor is one, the conventional linear algorithm is used instead). Given the split factor F, a parallel-split all-to-all system divides the ranks P into F parallel groups. Within each group, a linear all-to-all communication is performed, but with a multiple of the message size (e.g., m×F amount of data is communicated between different ranks of the parallel group). Advantageously each rank communicates only with the other ranks in its parallel group, thereby reducing the number of communication channels that must be established between ranks compared to traditional methods.

Once the parallel groups have completed their internal all-to-all communication, the parallel-split all-to-all system reorganizes the ranks into exchange groups. Exchange group assignments are determined using split factor. For instance, each rank number is divided by the split factor, and the decimal portion is discarded (i.e., a floor operation is performed). For example, if P=8 and F=2, dividing the ranks by F results in four exchange groups: E0 (ranks 0 and 1), E1 (ranks 2 and 3), E2 (ranks 4 and 5), and E3 (ranks 6 and 7). The parallel-split all-to-all system completes the all-to-all data transfer by causing ranks to exchange data blocks among one or more other ranks included in their respective exchange group. This final exchange ensures that all ranks have received their required data from the initial parallel group communications, and in the correct order.

The parallel-split all-to-all techniques described herein provide several significant advantages over traditional all-to-all techniques. For instance, the described techniques achieve all-to-all data communication using reduced communication rounds. In contrast to the conventional linear algorithm, which requires P−1 communication rounds for each rank to communicate with every other rank, the described techniques reduce this requirement by introducing a split factor that groups ranks and limits the number of communication channels that need to be established. The total number of communication rounds becomes (P/F+F−2), which is substantially fewer than the linear method, particularly for larger numbers of ranks and smaller message sizes. Advantageously, this reduction minimizes communication overhead and improves overall computational system efficiency. Additionally, the dynamic adjustment of communication strategy based on message size, number of ranks, and rank-to-rank latency offers a flexibility that is not realized in conventional methods. By varying F, the described techniques adapt to different data and system configurations, optimizing communication based on the specific requirements of the task for a broad range of data sizes and system architectures.

In some aspects, the techniques described herein relate to a method implemented by at least one computing device, the method including assigning a plurality of ranks to a plurality of parallel groups, exchanging, within each of the plurality of parallel groups, data blocks among a subset of the plurality of ranks assigned to the parallel group, assigning the plurality of ranks to a plurality of exchange groups, and communicating, by each of the plurality of ranks, at least one data block with each other rank of the plurality of ranks that is assigned to a same exchange group as the rank.

In some aspects, the techniques described herein relate to a method, wherein a number of the plurality of parallel groups is defined based on a split factor.

In some aspects, the techniques described herein relate to a method, further including deriving the split factor by estimating a communication latency between adjacent ranks of the plurality of ranks.

In some aspects, the techniques described herein relate to a method, wherein estimating the communication latency between adjacent ranks of the plurality of ranks is performed based on a hardware architecture of the at least one computing device.

In some aspects, the techniques described herein relate to a method, further including deriving the split factor based on a size of the at least one data block.

In some aspects, the techniques described herein relate to a method, further including deriving the split factor based on a number of the plurality of ranks.

In some aspects, the techniques described herein relate to a method, further including deriving the split factor based on a threshold data block size.

In some aspects, the techniques described herein relate to a method, wherein exchanging data blocks among the subset of the plurality of the ranks assigned to the parallel groups includes each rank of the subset of the plurality of the ranks communicating a number of data blocks to each other rank of the subset of the plurality of ranks, wherein the number of the data blocks is defined by the split factor.

In some aspects, the techniques described herein relate to a method, wherein exchanging data blocks among the subset of the plurality of the ranks assigned to the parallel groups is performed independent of establishing a communication channel between a rank of a parallel group and a rank of a different parallel group.

In some aspects, the techniques described herein relate to a method, wherein a number of the plurality of exchange groups is defined by a ratio of a number of the plurality of ranks relative to the split factor.

In some aspects, the techniques described herein relate to a method, wherein assigning the plurality of ranks to the plurality of parallel groups includes dividing a rank index by the split factor to identify a remainder value, wherein the remainder value identifies an index of one of the plurality of parallel groups.

In some aspects, the techniques described herein relate to a method, wherein assigning the plurality of ranks to the plurality of exchange groups includes dividing a rank index by the split factor and discarding a decimal remainder to identify an integer value, wherein the integer value identifies an index of one of the plurality of exchange groups.

In some aspects, the techniques described herein relate to a method, wherein communicating the at least one data block with each other rank of the plurality of ranks that is assigned to the same exchange group is performed independent of establishing a communication channel between a rank of an exchange group and a rank of a different exchange group.

In some aspects, the techniques described herein relate to a method, wherein the at least one data block communicated with each other rank of the plurality of ranks that is assigned to the same exchange group includes a plurality of data blocks, wherein the plurality of data blocks includes an amount defined by multiplying a number of the plurality of ranks by the split factor.

In some aspects, the techniques described herein relate to a system including at least one processing device executing a plurality of ranks, each of the plurality of ranks having an assigned plurality of data blocks, and a parallel-split all-to-all system configured to cause each of the plurality of ranks to communicate a respective one of the plurality of data blocks to each other rank of the plurality of ranks via a parallel-split all-to-all operation.

In some aspects, the techniques described herein relate to a system, wherein causing each of the plurality of ranks to communicate the respective one of the plurality of data blocks to each other rank of the plurality of ranks via a parallel-split all-to-all operation includes assigning the plurality of ranks to a plurality of parallel groups, exchanging, within each of the plurality of parallel groups, data blocks among a subset of the plurality of ranks assigned to the parallel group, assigning the plurality of ranks to a plurality of exchange groups, and communicating, by each of the plurality of ranks, at least one data block with each other rank of the plurality of ranks that is assigned to a same exchange group as the rank.

In some aspects, the techniques described herein relate to a system, wherein a number of the plurality of parallel groups is defined by a split factor.

In some aspects, the techniques described herein relate to a system, wherein the parallel-split all-to-all system derives the split factor by estimating a communication latency between adjacent ranks of the plurality of ranks, based on a size of the at least one data block, based on a number of the plurality of ranks, and based on an upper limit threshold data block size.

In some aspects, the techniques described herein relate to a device including at least one compute unit executing a plurality of ranks that are each assigned a plurality of data blocks, and executable code that causes the at least one compute unit to communicate, from each of the plurality of ranks, a respective one of the plurality of data blocks to each other rank of the plurality of ranks by assigning the plurality of ranks to a plurality of parallel groups, exchanging, within each of the plurality of parallel groups, data blocks among a subset of the plurality of ranks assigned to the parallel group, assigning the plurality of ranks to a plurality of exchange groups, and communicating, by each of the plurality of ranks, at least one data block with each other rank of the plurality of ranks that is assigned to a same exchange group as the rank.

In some aspects, the techniques described herein relate to a device, wherein the executable code further causes the at least one compute unit to derive a split factor used as part of communicating, from each of the plurality of ranks, the respective one of the plurality of data blocks to each other rank of the plurality of ranks, wherein the split factor is derived by estimating a communication latency between adjacent ranks of the plurality of ranks, based on a size of the at least one data block, based on a number of the plurality of ranks, and based on an upper limit threshold data block size.

### [Reserved—Claim Summary]

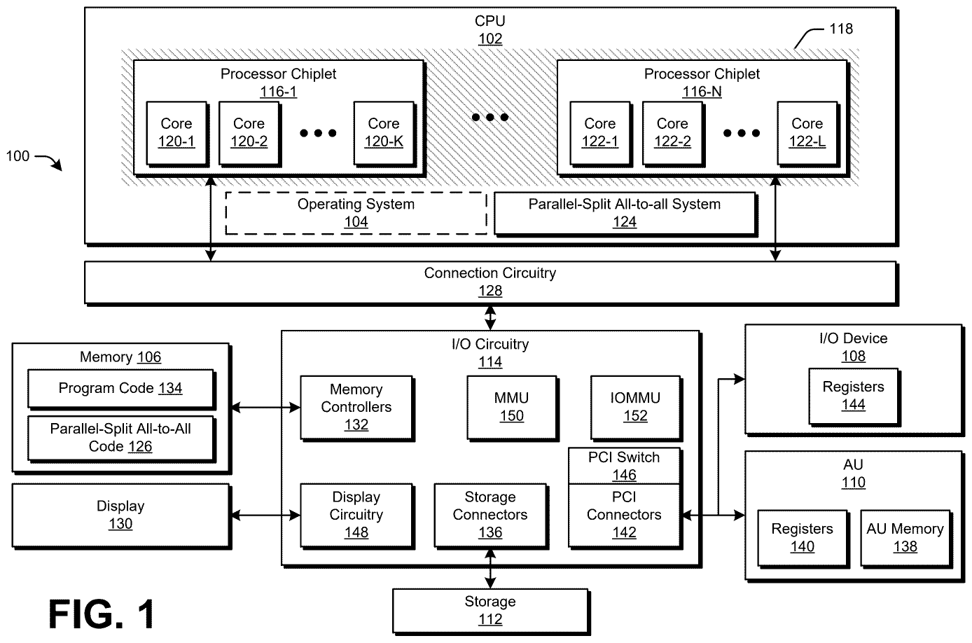

FIG. 1 is a block diagram of a processing system configured to execute one or more applications, in accordance with one or more implementations.

FIG. 1 includes a processing system 100 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 112, I/O circuitry 114) for the execution of tasks for the applications, provide an interface to I/O devices (e.g., I/O device 108) for the applications, or any combination thereof.

The CPU 102 includes one or more processor chiplets 116, which are communicatively coupled together by a data fabric 118 in one or more implementations.

Each of the processor chiplets 116, for example, includes one or more processor cores 120, 122 configured to concurrently execute one or more series of instructions, also referred to herein as “threads,” for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116. Though the example embodiment presented in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

To employ the techniques described herein, the processing system 100 includes a parallel-split all-to-all system 124, depicted in the illustrated example of FIG. 1 as incorporated in the CPU 102. In variations, however, the parallel-split all-to-all system 124 is included in and/or is implemented by one or more different components of the processing system 100, such as the memory 106, the I/O device 108, the AU 110, the storage 112, the I/O circuitry 114, and so forth. In at least one implementation, the parallel-split all-to-all system 124 or portions of the parallel-split all-to-all system 124 are included in at least two of the depicted components of the processing system 100. By way of example, the parallel-split all-to-all system 124 performs its functionality described herein by executing instructions stored in the memory 106, represented in the illustrated example of FIG. 1 as parallel-split all-to-all code 126.

Additionally, within the processing system 100, the CPU 102 is communicatively coupled to an I/O circuitry 114 by a connection circuitry 128. For example, each processor chiplet 116 of the CPU 102 is communicatively coupled to the I/O circuitry 114 by the connection circuitry 128. The connection circuitry 128 includes, for example, one or more data fabrics, buses, buffers, queues, and the like. The I/O circuitry 114 is configured to facilitate communications between two or more components of the processing system 100 such as between the CPU 102, system memory 106, display 130, universal serial bus (USB) devices, peripheral component interconnect (PCI) devices (e.g., I/O device 108, AU 110), storage 112, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 114 includes one or more memory controllers 132. These memory controllers 132, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, these memory controllers 132 are configured to manage access to the data stored at one or more memory addresses within the system memory 106, such as by CPU 102, the I/O device 108, and/or the AU 110.

When an application is to be executed by processing system 100, the OS 104 running on the CPU 102 is configured to load at least a portion of program code 134 (e.g., an executable file) associated with the application from, for example, a storage 112 into system memory 106. This storage 112, for example, includes a non-volatile storage such as a flash memory, solid-state memory, hard disk, optical disc, or the like configured to store program code 134 for one or more applications.

To facilitate communication between the storage 112 and other components of processing system 100, the I/O circuitry 114 includes one or more storage connectors 136 (e.g., universal serial bus (USB) connectors, serial AT attachment (SATA) connectors, PCI Express (PCIe) connectors) configured to communicatively couple storage 112 to the I/O circuitry 114 such that I/O circuitry 114 is capable of routing signals to and from the storage 112 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 138. This AU memory 138, for example, includes any combination of one or more volatile memories and/or non-volatile memories, examples of which include caches, video RAM (VRAM), or the like. In one or more implementations, these compute units are also configured to execute these threads based on the data stored in one or more physical registers 140 of the AU 110.

To facilitate communication between the AU 110 and one or more other components of processing system 100, the I/O circuitry 114 includes or is otherwise connected to one or more connectors, such as PCI connectors 142 (e.g., PCIe connectors) each including circuitry configured to communicatively couple the AU 110 to the I/O circuitry such that the I/O circuitry 114 is capable of routing signals to and from the AU 110 to one or more other components of the processing system 100. Further, the PCIe connectors 142 are configured to communicatively couple the I/O device 108 to the I/O circuitry 114 such that the I/O circuitry 114 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 144 of the I/O device 108. In one or more implementations, such physical registers 144 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 142, and one or more other components of the processing system 100, the I/O circuitry 114 includes PCI switch 146. The PCI switch 146, for example, includes circuitry configured to route packets to and from the components of the processing system 100 connected to the PCI connectors 142 as well as to the other components of the processing system 100. As an example, based on address data indicated in a packet received from a first component (e.g., CPU 102), the PCI switch 146 routes the packet to a corresponding component (e.g., AU 110) connected to the PCI connectors 142.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 112, displays the scene on the display 130, or both. The display 130, for example, includes a cathode-ray tube (CRT) display, liquid crystal display (LCD), light emitting diode (LED) display, organic light emitting diode (OLED) display, or any combination thereof. To enable the processing system 100 to display a scene on the display 130, the I/O circuitry 114 includes display circuitry 148. The display circuitry 148, for example, includes high-definition multimedia interface (HDMI) connectors, DisplayPort connectors, digital visual interface (DVI) connectors, USB connectors, and the like, each including circuitry configured to communicatively couple the display 130 to the I/O circuitry 114. Additionally or alternatively, the display circuitry 148 includes circuitry configured to manage the display of one or more scenes on the display 130 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 114 includes memory management unit (MMU) 146 and input-output memory management unit (IOMMU) 148. The MMU 150 includes, for example, circuitry configured to manage memory requests, such as from the CPU 102 to the system memory 106. For example, the MMU 150 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 150 is configured to translate the virtual address indicated in the memory request to a physical address in the system memory 106 and to fulfill the request. The IOMMU 152 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 144 of the I/O device 108, the registers 140 of the AU 110, and/or the AU memory 138, the CPU 102 issues one or more MMIO requests. Such MMIO requests each request access to read, write, fetch, or pre-fetch data residing at one or more virtual addresses (e.g., guest virtual addresses) which each represent at least a portion of the registers 144 of the I/O device 108, the registers 140 of the AU 110, or the AU memory 138, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 152 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The processing system 100 is configurable in a variety of ways with different combinations of components in accordance with the described techniques.

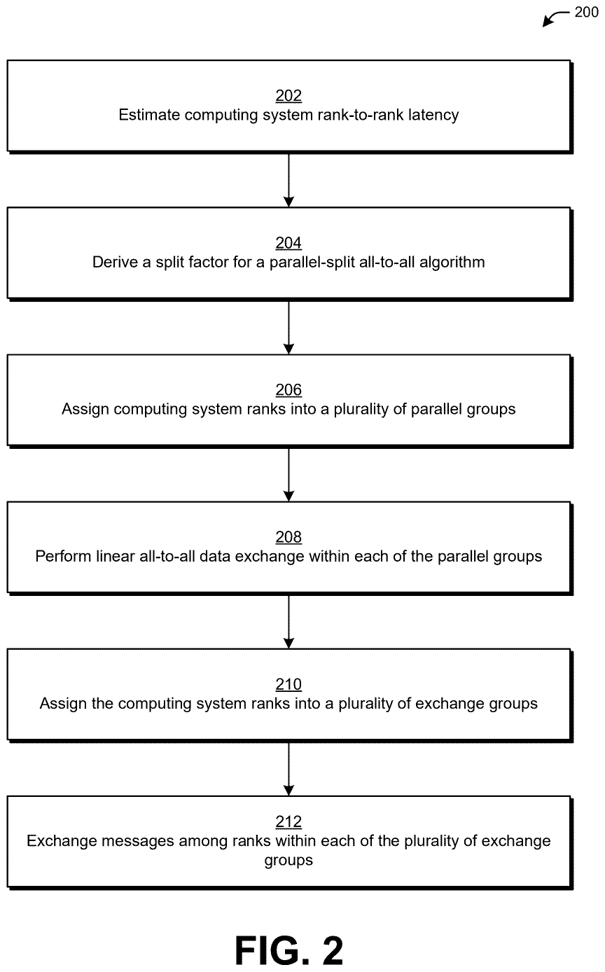

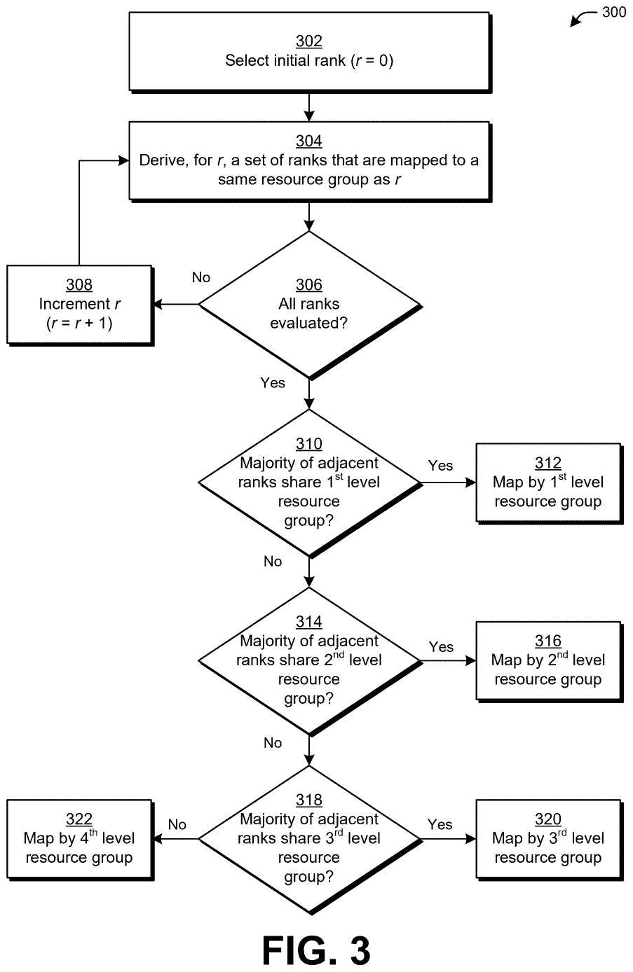

FIG. 2 depicts a procedure 200 in an example implementation of the parallel-split all-to-all system 124 performing data communication among a group of ranks using the techniques described herein. The following description of FIG. 2 is made with references to FIGS. 3-10 for additional context.

To begin, a computing system rank-to-rank latency is estimated (block 202). The parallel-split all-to-all system 124, for instance, estimates a communication latency between different ranks implemented by a hardware configuration of the processing system 100. For a detailed description regarding how the parallel-split all-to-all system 124 estimates a rank-to-rank latency, consider FIG. 3.

FIG. 3 depicts a procedure 300 in an example implementation of the parallel-split all-to-all system 124 estimating a rank-to-rank communication latency between different ranks implemented by the processing system 100. To begin, an initial rank (e.g., rank zero) is selected (block 302). For the selected rank, a set of ranks that are mapped to a same resource group as the selected rank is derived (block 304). The parallel-split all-to-all system 124, for instance, identifies a hierarchical memory resource group (e.g., L3 cache, NUMA domain, socket, etc.) to which a rank is mapped using any suitable technique. In some implementations, the parallel-split all-to-all system 124 identifies a rank's memory resource group by leveraging topology of the processing system 100 and memory management mechanisms of the OS 104. As a specific example, for caches like L3, which are shared among multiple cores (e.g., core 120-1 to core 120-K), the parallel-split all-to-all system 124 determines which cores have access to a given L3 cache through its internal architecture. The OS 104 is configured to use system calls to bind a process or thread to specific cores. By examining the affinity of a rank to a bound core, the parallel-split all-to-all system 124 is able to derive which cache hierarchy the selected rank is using.

For NUMA domains, the NUMA domain can be determined by examining the memory 106 locality and the processor chiplet 116 on which the rank is executing. For sockets, the architecture of processing system 100 groups cores (e.g., cores 120 and cores 122) and memory 106 under physical CPU sockets, and the OS 104 can map ranks to specific sockets using scheduling and memory management policies. Thus, by observing processing system 100 topology, process scheduling, and memory allocation, the parallel-split all-to-all system 124 is configured to identify the specific memory resource group used by a rank, such as a core, a L3 cache, a NUMA domain, a socket, and so forth.

After deriving, for a selected rank, other ranks that are mapped to a common resource group as the selected rank, a determination is made as to whether all ranks have been evaluated (block 306). If all ranks have not been evaluated (e.g., a “No” determination at block 306), the value of r is incremented (block 308) (e.g., previously considered rank zero is incremented to next evaluate rank one), and operation of the procedure 300 returns to block 304. This loop continues until the parallel-split all-to-all system 124 has evaluated all ranks to identify which ranks are mapped to common resource groups (e.g., common hierarchical memory resources).

Upon evaluating all ranks (e.g., a “Yes” determination at block 306), a determination is made as to whether a majority of adjacent ranks share a common first level resource group (block 310). The evaluation of whether adjacent ranks share a common resource group is significant, as rank adjacency is essential in ensuring the proper ordering of data transfer in an all-to-all operation.

As a specific example, consider a scenario where data is to be communicated among eight ranks, where four ranks share one L3 cache and the remaining four ranks share a different L3 cache. In this specific example, ranks 0, 1, 2, and 3 share a first L3 cache and include three pairs of adjacent ranks that share the first L3 cache (e.g., rank 0 and rank 1; rank 1 and rank 2; and rank 2 and rank 3). Continuing this specific example, ranks 4, 5, 6, and 7 share a second L3 cache and include three pairs of adjacent ranks that share the second L3 cache (e.g., rank 4 and rank 5; rank 5 and rank 6; and rank 6 and rank 7). In this specific example, there are two pairs of adjacent ranks that do not share a common L3 cache (e.g., rank 3 and rank 4; and rank 7 and rank 0). Thus, in this specific example, there are 6 pairs of adjacent ranks that share a common L3 cache and 2 pairs of adjacent ranks that share a different level resource group (e.g., a common NUMA domain).

Returning to FIG. 3, in response to determining that a majority of adjacent ranks share a common first level resource group (e.g., a “Yes” determination at block 310), an average rank-to-rank latency is determined by mapping the rank-to-rank latency according to a shared first level resource group (block 312). As part of mapping the rank-to-rank latency based on a first level resource group, the parallel-split all-to-all system 124 assigns an upper limit message size, my, for use in deriving a split factor, as described in further detail below based on the first level resource group. As a specific example, in a scenario where the first level resource group represents a shared L3 cache, the parallel-split all-to-all system 124 assigns an upper limit message size of 4096 bytes.

Alternatively, in response to determining that a majority of adjacent ranks do not share a common first level resource group (e.g., a “No” determination at block 312), a determination is made as to whether the majority of adjacent ranks share a common second level resource group (block 314). In response to determining that the majority of adjacent ranks share a common second level resource group (e.g., a “Yes” determination at block 314), the average rank-to-rank latency is determined by mapping the rank-to-rank latency according to a shared second level resource group (block 316). As part of mapping the rank-to-rank latency based on a second level resource group, the parallel-split all-to-all system 124 assigns the upper limit message size based on the second level resource group. As a specific example, in a scenario where the second level resource group represents a shared NUMA domain, the parallel-split all-to-all system 124 assigns an upper limit message size of 2048 bytes.

Alternatively, in response to determining that a majority of adjacent ranks do not share a common second level resource group (e.g., a “No” determination at block 314), a determination is made as to whether the majority of adjacent ranks share a common third level resource group (block 318). In response to determining that the majority of adjacent ranks share a common third level resource group (e.g., a “Yes” determination at block 318), the average rank-to-rank latency is determined by mapping the rank-to-rank latency according to a shared third level resource group (block 320). As part of mapping the rank-to-rank latency based on a third level resource group, the parallel-split all-to-all system 124 assigns the upper limit message size based on the third level resource group. As a specific example, in a scenario where the third level resource group represents a shared socket, the parallel-split all-to-all system 124 assigns an upper limit message size of 1024 bytes.

Alternatively, in response to determining that a majority of adjacent ranks do not share a common third level resource group (e.g., a “No” determination at block 318), the average rank-to-rank latency is determined by mapping the rank-to-rank latency according to a shared fourth level resource group (block 322). As part of mapping the rank-to-rank latency based on a fourth level resource group, the parallel-split all-to-all system 124 assigns the upper limit message size based on the fourth level resource group. As a specific example, in a scenario where the fourth level resource group represents a shared node, the parallel-split all-to-all system 124 assigns an upper limit message size of 512 bytes.

The example upper limit message sizes noted above are not intended to be limiting. Rather, the example upper limit message sized represent how an upper limit message size will generally be smaller when adjacent rank pairs share resource groups that have higher data transfer latency. Conversely, an upper limit message size will generally be larger when adjacent rank pairs share resource groups that have lower data transfer latency. Thus, the parallel-split all-to-all system 124 considers the hierarchical nature of memory and considers how a communication between two ranks would be affected based on an underlying architecture of the processing system 100.

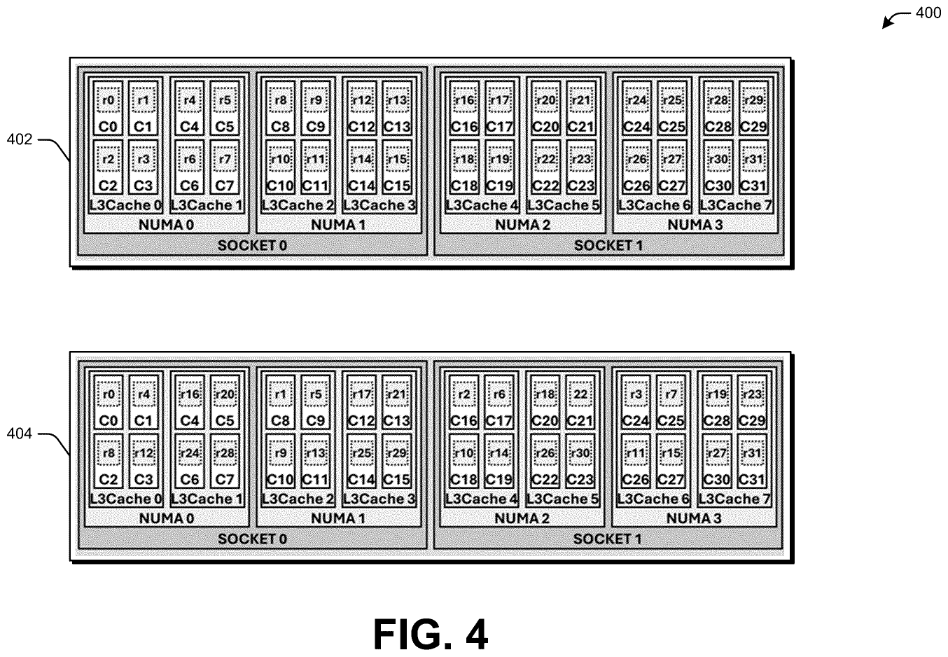

For an illustrated example of how different memory architectures impact rank-to-rank latencies, consider FIG. 4.

FIG. 4 depicts an example 400 of different hierarchical memory structures that result in different rank-to-rank latencies. Specifically, the example 400 depicts structure 402 and structure 404. Structure 402 and structure 404 each depict a single node that includes two sockets (socket 0 and socket 1), four NUMA domains (NUMA 0, NUMA 1, NUMA 2, and NUMA 3), eight L3 caches (L3 cache 0, L3 cache 1, L3 cache 2, L3 cache 3, L3 cache 4, L3 cache 5, L3 cache 6, and L3 cache 7), 32 cores (C0, C1, . . . . C31), and 32 ranks (r0, r1, . . . r31). In both structure 402 and structure 402, there are 32 adjacent rank pairs (r0,r1; r1,r2; r2,r3; . . . r30,r31; and r31,r0).

In structure 402, 24 adjacent rank pairs share a common L3 cache, four adjacent rank pairs share a common NUMA domain, two adjacent rank pairs share a common socket, and two adjacent rank pairs share a common node. Thus, the majority of adjacent rank pairs share a common L3 cache (e.g., a common first level resource group) and the parallel-split all-to-all system 124 assigns an upper limit message size based on this mapping to a common L3 cache. Conversely, in structure 404, no adjacent rank pairs share a common L3 cache, no adjacent rank pairs share a common NUMA domain, 16 adjacent rank pairs share a common socket, and 16 adjacent rank pairs share a common node. Thus, no single majority of adjacent rank pairs share a common level resource group (e.g., 16 adjacent rank pairs share a common socket, and 16 adjacent rank pairs share a common node). In this scenario, the parallel-split all-to-all system 124 favors the faster communication afforded by a shared socket relative to the slower communication afforded by a shared node and assigns an upper limit message size based on this mapping to a common socket.

In this manner, the parallel-split all-to-all system 124 advantageously considers the hierarchical nature of memory when estimating an average rank-to-rank communication latency, thereby dynamically adapting to the specific hardware configuration of a computing system implementing the parallel-split all-to-all system 124, which is not possible using conventional techniques.

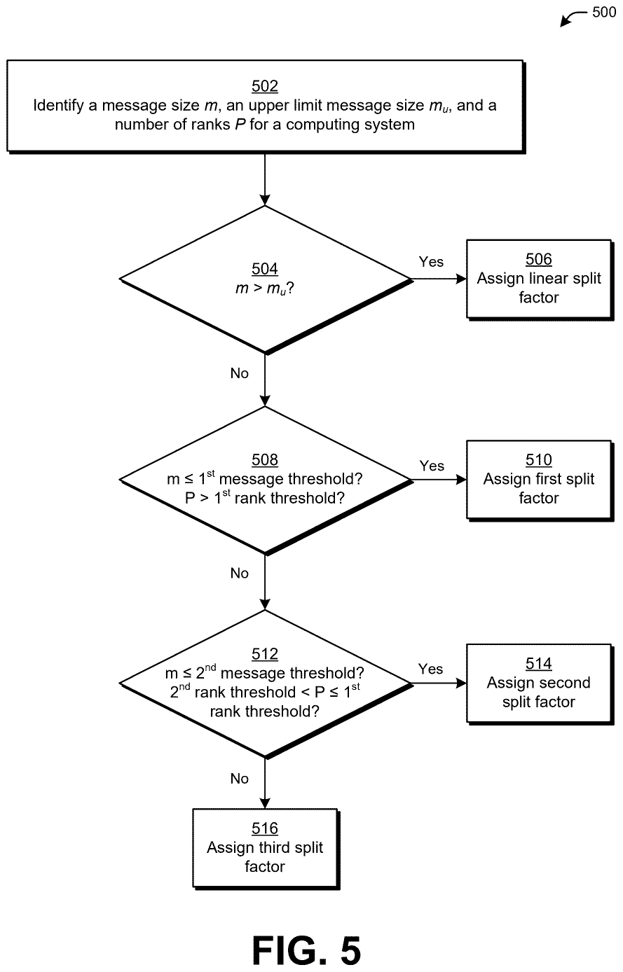

Returning to FIG. 2, after estimating the computing system rank-to-rank latency, a split factor is derived for a parallel-split all-to-all algorithm (block 204). For a detailed description of deriving a split factor, consider FIG. 5.

FIG. 5 depicts a procedure 500 in an example implementation of the parallel-split all-to-all system 124 deriving a split factor for use in performing a parallel-split all-to-all operation in accordance with the techniques described herein.

To begin, a message size m, an upper limit message size my, and a number of ranks P are determined (block 502). The parallel-split all-to-all system 124, for instance, identifies a size (e.g., expressed in bytes) of each data block to be transferred from one rank to another rank during an all-to-all operation, and identifies a total number of ranks to be involved in the all-to-all operation. The parallel-split all-to-all system 124 identifies the upper limit message size based on the resource group mapping as described above with respect to FIG. 3.

A determination is then made as to whether the message size is greater than the upper limit message size (block 504). In response to determining that m>mᵤ (e.g., a “Yes” determination at block 504), a linear split factor F is assigned (e.g., F=1) (block 506). In such implementations, the parallel-split all-to-all algorithm implemented by the parallel-split all-to-all system 124 operates similar to the conventional linear algorithm as described above.

Conversely, in response to determining that the message size is less than the upper limit message size (e.g., a “No” determination at block 504), a determination is made as to whether the message size is less than or equal to a first message size threshold and whether the number of ranks is greater than a first rank threshold (block 508). In implementations, the first message size threshold and the first rank threshold are heuristically determined (e.g., based on observations of previous all-to-all operations performed by the parallel-split all-to-all system 124). In some implementations, the first message size threshold is defined based on the upper limit message sizes assigned to different resource groups as described with respect to FIG. 3. For instance, in an example scenario the first message size threshold is 512 bytes, and the first rank threshold is 96 ranks.

In response to determining that the message size is less than or equal to the first message size threshold and that the number of ranks is greater than the first rank threshold (e.g., a “Yes” determination at block 508), a first split factor is assigned (block 510). The parallel-split all-to-all system 124, for instance, assigns a first split factor of eight.

Alternatively, in response to determining that the message size is not less than or equal to the first message size threshold, or that the number of ranks is not greater than the first rank threshold (e.g., a “No” determination at block 508), a determination is made as to whether the message size is less than or equal to a second message size threshold and whether the number of ranks is greater than a second rank threshold and less than or equal to the first rank threshold (block 512). In implementations, the second message size threshold and the second rank threshold are heuristically determined (e.g., based on observations of previous all-to-all operations performed by the parallel-split all-to-all system 124). In some implementations, the second message size threshold is defined based on the upper limit message sizes assigned to different resource groups as described with respect to FIG. 3. For instance, in an example scenario the second message size threshold is 1024 bytes, and the second rank threshold is 8 ranks.

In response to determining that the message size is less than or equal to the second message size threshold and that the number of ranks is greater than the second rank threshold and less than or equal to the first rank threshold (e.g., a “Yes” determination at block 512), a second split factor is assigned (block 514). The parallel-split all-to-all system 124, for instance, assigns a second split factor of four.

Alternatively, in response to determining that the message size is not less than or equal to the second message size threshold, or that the number of ranks is not greater than the second rank threshold and less than or equal to the first rank threshold (e.g., a “No” determination at block 512), a third split factor is assigned (block 516). The parallel-split all-to-all system 124, for instance, assigns a third split factor of two. Although described with respect to example split factors (e.g., F=1,2, 4, or 8), the described split factors and respective thresholds upon which the are determined, are not limiting and the describe techniques are extendable to any combination of split factors, rank thresholds, and message size thresholds.

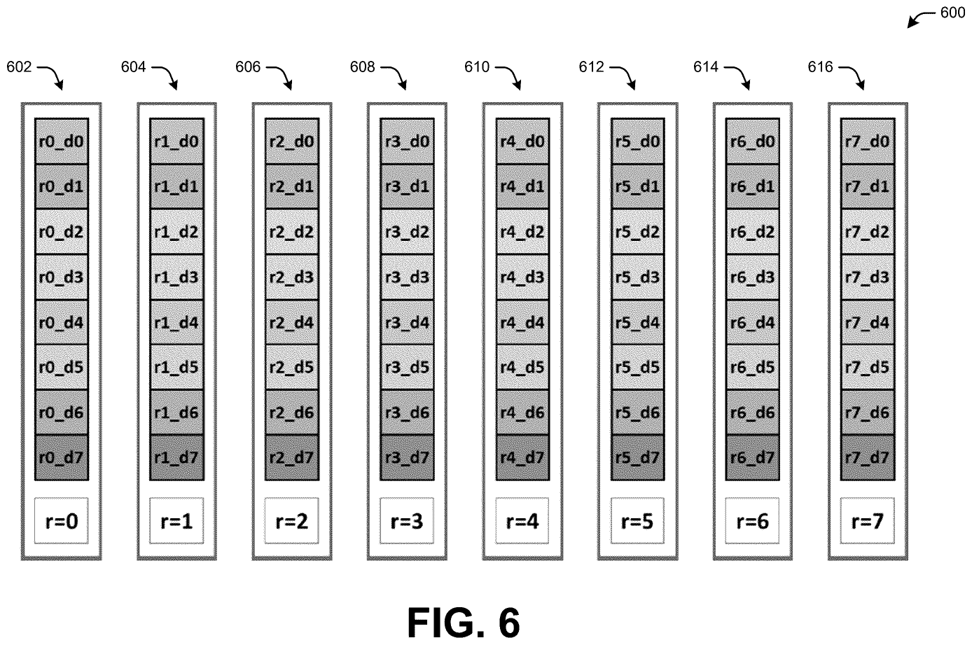

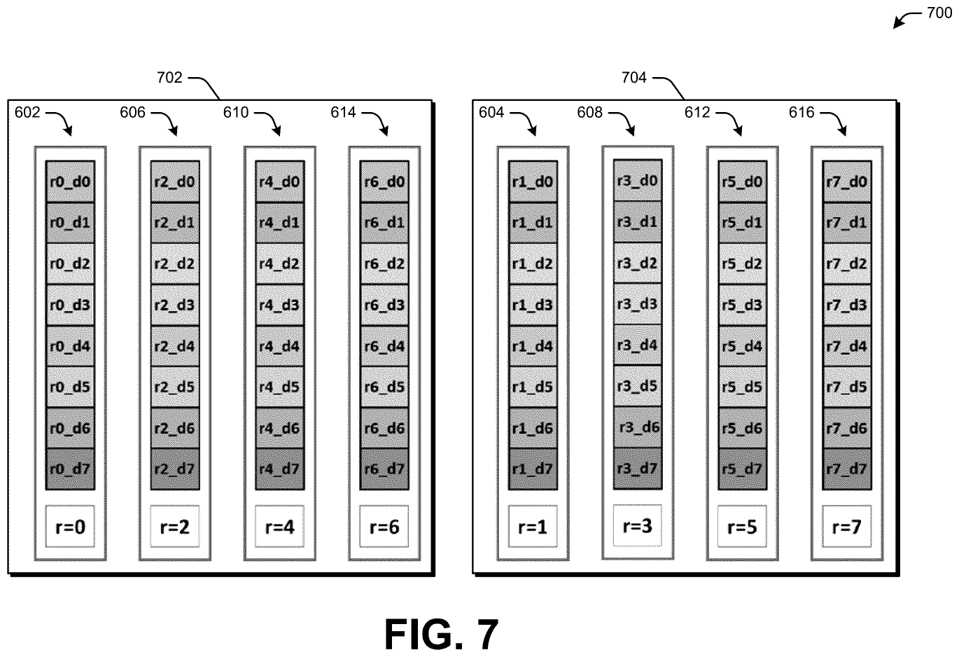

Returning to FIG. 2, the ranks are assigned into a plurality of parallel groups based on the derived split factor (block 206). Assigning the ranks into the plurality of parallel groups involves assigning subsets of the plurality of ranks into individual ones of the plurality of parallel groups. In some implementations, each parallel group includes an equivalent number of ranks (e.g., a subset of ranks included in one parallel group includes a same number of ranks as a subset of ranks included in another parallel group). Assigning ranks into a parallel group based on the split factor can be expressed by the modulo operator mod, or P mod F=r, where P represents the number of ranks, F represents the split factor, and r represents the remainder of the modulo operation, as described in further detail below with respect to the illustrated examples of FIGS. 6 and 7.

As a specific example, consider a scenario where the split factor is two and eight ranks are to be divided into a number of parallel groups dictated by the split factor. To illustrate this example scenario, consider FIG. 6.

FIG. 6 depicts an example 600 of ranks that include data blocks to be transferred, from a given rank to each other rank, during an all-to-all operation. In the illustrated example 600, rank 602 represents a first rank (e.g., r0), rank 604 represents a second rank (e.g., r1), rank 606 represents a third rank (e.g., r2), rank 608 represents a fourth rank (e.g., r3), rank 610 represents a fifth rank (e.g., r4), rank 612 represents a sixth rank (e.g., r5), rank 614 represents a seventh rank (e.g., r6), and rank 616 represents an eighth rank (e.g., r7).

Each rank 602-616 includes eight data blocks, one for each rank in the group of ranks depicted in the illustrated example of FIG. 6. Each data block in the illustrated example of FIG. 6 is labeled as rX_d #, where the “X” prefix indicates that the data block originates from rank X, while the “d #” suffix indicates the destination rank of the data block (for example, r0d3 will be communicated from rank 0 to rank 3 at completion of the all-to-all operation).

Continuing the scenario where the ranks illustrated in FIG. 6 are to be divided into F parallel groups, and where the split factor F=2, FIG. 7 depicts how the ranks of FIG. 6 are organized into parallel groups.

FIG. 7 depicts an example 700 of ranks that have been divided into parallel groups based on a split factor derived for an all-to-all operation using the techniques described herein. Because the illustrated example 700 depicts a specific scenario of a split factor equal to two, the example 700 includes two parallel groups: parallel group 702 and parallel group 704. In the illustrated example of FIG. 7, parallel group 702 includes rank 602, rank 606, rank 610, and rank 614. Parallel group 704 includes rank 604, rank 608, rank 612, and rank 616. In implementations, the assignment of a rank to a parallel group (e.g., parallel group 702 or parallel group 704) is determined by the parallel-split all-to-all system 124 using a modulo operation. For instance, if the numerical representation of a rank (e.g., r) modulo the split factor is equal to an integer, then the rank is assigned to a parallel group identified by the integer. This assignment of a rank to a parallel group can be expressed according to Equation 1, where r represents the rank's numerical value, F is the split factor, and/represents the parallel group index to which the rank is assigned (e.g., I is the remainder after performing r mod F):

$$r mod F = I ⇒ r ∈ {G}_{I} \qquad ( Eq . 1 )$$

The illustrated example of FIG. 7 depicts a specific scenario where eight ranks are divided into two parallel groups, and is not intended to be limiting, as the described techniques are extendable to any number of ranks and any number of parallel groups. Returning to FIG. 2, a linear all-to-all data exchange is performed within each of the parallel groups (block 208). In contrast to a conventional linear all-to-all operation as described above, however, ranks of a given parallel group communicate data blocks to other ranks of the parallel group at a multiple defined by the split factor (e.g., continuing the above example where the split factor is two, each rank communicates two data blocks to every other rank included in its parallel group. Advantageously, exchanging data within each of the parallel groups is performed independent of (e.g., without) establishing a communication channel between parallel groups (e.g., no communication channel is established between a rank of one parallel group and a rank of a different parallel group).

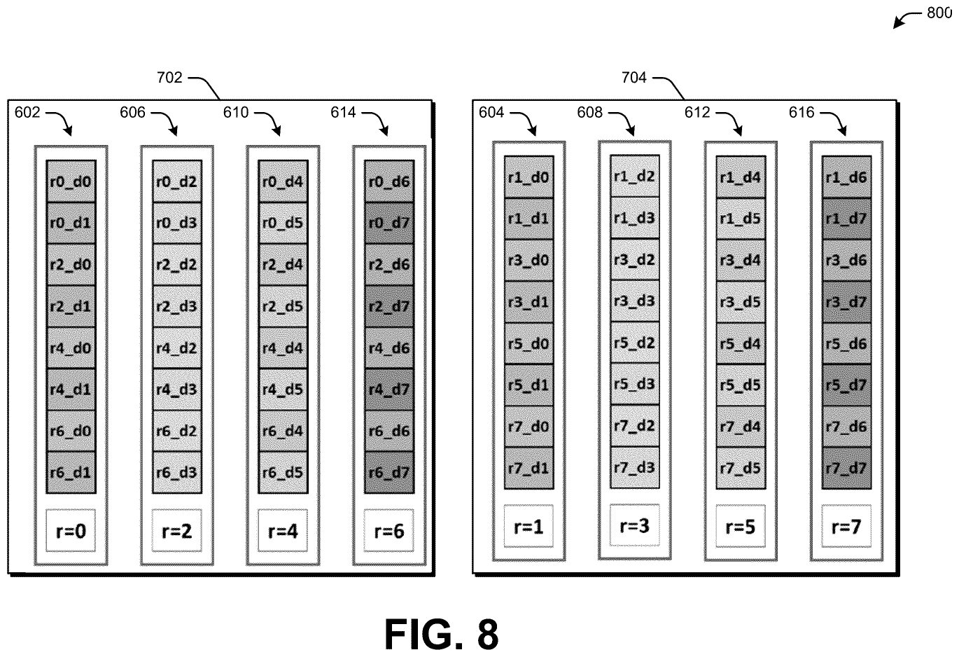

FIG. 8 depicts an example 800 of ranks that have performed a linear all-to-all operation with other ranks of their parallel group, by communicating a split factor number of data blocks to each other rank in the parallel group, as part of performing a parallel-split all-to-all operation. In the illustrated example 800, continuing the examples of FIGS. 6 and 7 where the split factor is two, each rank is depicted as having received two data blocks from every other rank in its parallel group. For instance, rank 602 includes r2_d0 and r2_d1 from rank 606, r4_d0 and r4_d1 from rank 610, and r6_d0 and r6_d1 from rank 614. As will be realized in view of the following description, this linear all-to-all data exchange within a parallel group advantageously positions data blocks for communication among ranks of a common exchange group, which minimizes the number of communication channels that are established during a parallel-split all-to-all operation (e.g., relative to conventional all-to-all operations).

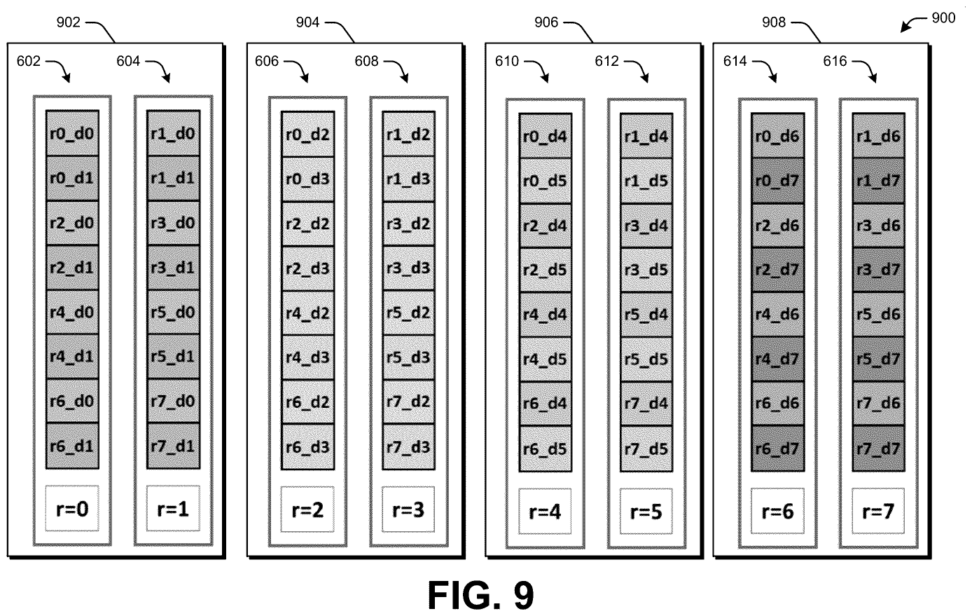

Returning to FIG. 2, after performing the linear-all-to-all operation within each parallel group, the computing system ranks are assigned into a plurality of exchange groups (block 210). While a quantity of the parallel groups was determined based on the split factor alone, a quantity of exchange groups into which the ranks are assigned is determined as a ratio of the number of ranks P relative to the split factor F, such that the number of exchange groups equals P/F. Continuing the above example where a split factor of two is derived for eight ranks, thus results in four exchange groups (e.g., 8/4=2). In implementations, assigning ranks to exchange groups is performed by dividing each rank number by the split factor and discarding any remaining decimal value. For a further description of assigning ranks into exchange groups, consider FIG. 9.

FIG. 9 depicts an example 900 of ranks that have been assigned into exchange groups based on a split factor derived for an all-to-all operation using the techniques described herein. Specifically, the illustrated example of FIG. 9 continues the above examples of FIGS. 6-8, where a split factor of two is derived for eight ranks, resulting in four exchange groups: exchange group 902, exchange group 904, exchange group 906, and exchange group 908. Exchange group 902 is depicted as including rank 602 and rank 604, exchange group 904 is depicted as including rank 606 and 608, exchange group 906 is depicted as including rank 610 and rank 612, and exchange group 908 is depicted as including rank 614 and rank 616. In this illustrated example, exchange group 902 has an index of zero, exchange group 904 has an index of one, exchange group 906 has an index of two, and exchange group 908 has an index of three.

Assigning ranks to each of the exchange groups is thus performed by dividing the rank's numerical value r by the split factor F and discarding any remaining decimal. For instance, continuing the above example where F=2, dividing r=0 and r=1 by 2 results in 0 and 0.5, respectively. Discarding the remainder decimal (e.g., 0.5) results in zero for both r=0 and r=1, which consequently results in assigning r=0 and r=1 to the exchange group having an index of zero (e.g., exchange group 902). This division of a rank's numerical value by the split factor and discarding any remaining decimal can be extrapolated to identify how rank 606 and rank 608 are assigned to the exchange group having an index of one (e.g., exchange group 904), how rank 610 and rank 612 are assigned to the exchange group having an index of two (e.g., exchange group 906), and how rank 614 and rank 616 are assigned to the exchange group having an index of three (e.g., exchange group 908).

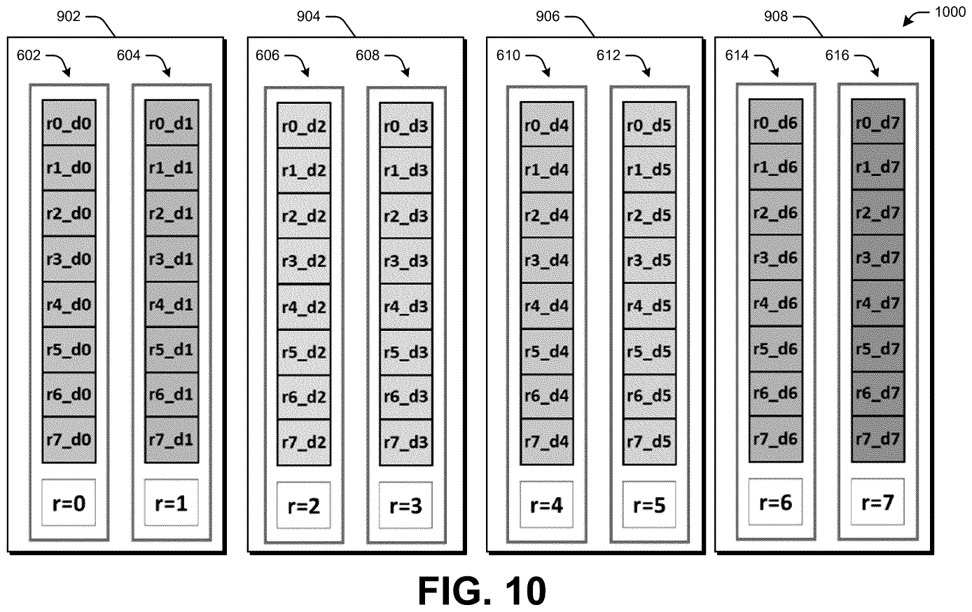

Returning to FIG. 2, after assigning the ranks to a plurality of exchange groups, messages are exchanged among ranks within each of the plurality of exchange groups (block 212). Specifically, P× F blocks of data are communicated among the F ranks of a given exchange group. Stated differently, for each rank pair (rₘ, rₙ) in an exchange group, where m=0,1, . . . , (F−1), n=0,1, . . . , (F−1), and m≠n, m units of data are exchanged with exchange m units of data at (k·F+(rₙ% F)) of rₘ's buffer with (k·F+(rₘ% F)) of rₙ's buffer, where k=0,1, . . . , (PF−1). For an illustration depicting how data blocks of an exchange group are communicated to their final rank, consider FIG. 10.

FIG. 10 depicts an example 1000 of ranks of a given exchange group that have received data blocks from other ranks of the exchange group as part of a parallel-split all-to-all operation using the techniques described herein.

In the illustrated example of FIG. 10, rank 602 is depicted as having received P×F blocks of data from rank 604. Similarly, rank 604 is depicted as having received P×F blocks of data from rank 602. Given the data block ordering constraints enforced by the parallel-split all-to-all techniques described herein, rank 602 includes one data block from every other rank upon completion of this communication of data within a given exchange group. Likewise, each rank includes one data block from every other rank upon completion of this communication of data within a given exchange group. Thus, the described techniques achieve all-to-all communications in a manner that reduces, relative to conventional techniques, an amount of different ranks with which a given rank needs to communicate. This advantageously reduces a number of communication channels that need to be established, which is not possible using conventional algorithms that fail to adapt based on a hardware configuration of the computing system implementing the parallel-split all-to-all system 124, the number of ranks, and the message size of each data block communicated between ranks.

The example techniques described herein are merely illustrative and many variations are possible based on this disclosure. Although features and elements are described above in particular combinations, each feature or element is usable alone without the other features and elements or in various combinations with or without other features and elements. In one or more implementations, the methods and procedures provided herein are implemented in a computer program, software, or firmware incorporated in a non-transitory computer-readable storage medium for execution by a processing device, such as a processing system described with respect to FIG. 1.

What is claimed is:

1. A method implemented by at least one computing device, the method comprising:
assigning a plurality of ranks to a plurality of parallel groups;
exchanging, within each of the plurality of parallel groups, data blocks among a subset of the plurality of ranks assigned to the parallel group;
assigning the plurality of ranks to a plurality of exchange groups; and
communicating, by each of the plurality of ranks, at least one data block with each other rank of the plurality of ranks that is assigned to a same exchange group as the rank.

2. The method of claim 1, wherein a number of the plurality of parallel groups is defined based on a split factor.

3. The method of claim 2, further comprising deriving the split factor by estimating a communication latency between adjacent ranks of the plurality of ranks.

4. The method of claim 3, wherein estimating the communication latency between adjacent ranks of the plurality of ranks is performed based on a hardware architecture of the at least one computing device.

5. The method of claim 2, further comprising deriving the split factor based on a size of the at least one data block.

6. The method of claim 2, further comprising deriving the split factor based on a number of the plurality of ranks.

7. The method of claim 2, further comprising deriving the split factor based on a threshold data block size.

8. The method of claim 2, wherein exchanging data blocks among the subset of the plurality of the ranks assigned to the parallel groups comprises each rank of the subset of the plurality of the ranks communicating a number of data blocks to each other rank of the subset of the plurality of ranks, wherein the number of the data blocks is defined by the split factor.

9. The method of claim 1, wherein exchanging data blocks among the subset of the plurality of the ranks assigned to the parallel groups is performed independent of establishing a communication channel between a rank of a parallel group and a rank of a different parallel group.

10. The method of claim 2, wherein a number of the plurality of exchange groups is defined by a ratio of a number of the plurality of ranks relative to the split factor.

11. The method of claim 2, wherein assigning the plurality of ranks to the plurality of parallel groups comprises dividing a rank index by the split factor to identify a remainder value, wherein the remainder value identifies an index of one of the plurality of parallel groups.

12. The method of claim 2, wherein assigning the plurality of ranks to the plurality of exchange groups comprises dividing a rank index by the split factor and discarding a decimal remainder to identify an integer value, wherein the integer value identifies an index of one of the plurality of exchange groups.

13. The method of claim 1, wherein communicating the at least one data block with each other rank of the plurality of ranks that is assigned to the same exchange group is performed independent of establishing a communication channel between a rank of an exchange group and a rank of a different exchange group.

14. The method of claim 2, wherein the at least one data block communicated with each other rank of the plurality of ranks that is assigned to the same exchange group comprises a plurality of data blocks, wherein the plurality of data blocks comprises an amount defined by multiplying a number of the plurality of ranks by the split factor.

15. A system comprising:
at least one processing device executing a plurality of ranks, each of the plurality of ranks having an assigned plurality of data blocks; and
a parallel-split all-to-all system configured to cause each of the plurality of ranks to communicate a respective one of the plurality of data blocks to each other rank of the plurality of ranks via a parallel-split all-to-all operation.

16. The system of claim 15, wherein causing each of the plurality of ranks to communicate the respective one of the plurality of data blocks to each other rank of the plurality of ranks via a parallel-split all-to-all operation comprises:
assigning the plurality of ranks to a plurality of parallel groups;
exchanging, within each of the plurality of parallel groups, data blocks among a subset of the plurality of ranks assigned to the parallel group;
assigning the plurality of ranks to a plurality of exchange groups; and
communicating, by each of the plurality of ranks, at least one data block with each other rank of the plurality of ranks that is assigned to a same exchange group as the rank.

17. The system of claim 16, wherein a number of the plurality of parallel groups is defined by a split factor.

18. The system of claim 17, wherein the parallel-split all-to-all system derives the split factor:
by estimating a communication latency between adjacent ranks of the plurality of ranks;
based on a size of the at least one data block;
based on a number of the plurality of ranks; and
based on an upper limit threshold data block size.

19. A device comprising:
at least one compute unit executing a plurality of ranks that are each assigned a plurality of data blocks; and
executable code that causes the at least one compute unit to communicate, from each of the plurality of ranks, a respective one of the plurality of data blocks to each other rank of the plurality of ranks by:
assigning the plurality of ranks to a plurality of parallel groups;
exchanging, within each of the plurality of parallel groups, data blocks among a subset of the plurality of ranks assigned to the parallel group;
assigning the plurality of ranks to a plurality of exchange groups; and
communicating, by each of the plurality of ranks, at least one data block with each other rank of the plurality of ranks that is assigned to a same exchange group as the rank.

20. The device of claim 19, wherein the executable code further causes the at least one compute unit to derive a split factor used as part of communicating, from each of the plurality of ranks, the respective one of the plurality of data blocks to each other rank of the plurality of ranks, wherein the split factor is derived:
by estimating a communication latency between adjacent ranks of the plurality of ranks;
based on a size of the at least one data block;
based on a number of the plurality of ranks; and
based on an upper limit threshold data block size.
